(19) United States
(12) Patent Application Publication
(10) Pub. No.: US 2025/0128629 A1
(43) Pub. Date: Apr. 24, 2025

(54) Portable Electrified Vehicle Backup Battery

(71) Applicant: Birch Sztabnik, Cold Spring Harbor, NY (US)

(72) Inventor: Birch Sztabnik, Cold Spring Harbor, NY (US)

(21) Appl. No.: 18/800,092

(22) Filed: Aug. 11, 2024

Related U.S. Application Data
(60) Provisional application No. 63/628,673, filed on Aug. 11, 2023.

(51) Int. Cl. B60L 53/57; B60L 53/12; B60L 53/16; B60L 53/18; B60L 53/53; B60L 53/66; B60R 16/04; H01M 10/613

(52) U.S. Cl. CPC B60L 53/57; B60L 53/12; B60L 53/16; B60L 53/18; B60L 53/53; B60L 53/66; B60R 16/04; H01M 10/613

(57) ABSTRACT

A portable electrified vehicle backup battery device includes a battery assembly that can be mounted and dismounted from a vehicle. The backup battery is able to recharge an electrified vehicle traction battery pack through a charging interface on the vehicle. The device can be rolled on the ground when it is dismounted from the vehicle. The backup battery system is capable of charging a vehicle when it is mounted or dismounted.

### TECHNICAL FIELD

The present disclosure relates to a backup battery which can be stowed in the place of a spare tire or wheel on a vehicle.

### BACKGROUND

Electrified vehicles use a traction battery pack comprised of a plurality of battery cells to power electrical devices which can partially or wholly propel the vehicle. The traction battery may need to be recharged away from a typical permanently installed charging station due to range miscalculations or vehicle location which necessitates the use of a portable battery backup.

### SUMMARY

The present disclosure demonstrates a system where an electrified vehicle is able to charge a traction battery pack using a portable electrified vehicle backup battery. The system is able to charge the traction battery pack using the portable backup battery. The backup battery is able to be mounted and dismounted to a vehicle. Features of the backup battery have been broadly outlined in order that the detailed description thereof may be better understood, and in order that the present contribution to the art may be better appreciated. The design of this backup battery is not limited by in its application by details set forth in this disclosure. The backup battery is capable of being constructed in various forms and the contributing art should not be regarded as limiting. Features may appear independently or in combination.

One object is to provide a method of transferring power between the backup battery and the electrified vehicle through physical or inductive coupling.

One object is to provide a portable electrified vehicle backup battery which includes a cordset to electrically couple the backup battery to the electrified vehicle charging port.

One object is to provide a portable electrified vehicle backup battery that is capable of charging an electrified vehicle in any location.

One object is to provide a portable electrified vehicle backup battery that has a shape which allows it to be rolled on the ground for lower effort transport when dismounted from the vehicle.

One object is to provide a portable electrified vehicle backup battery which can be recharged through connections to electrical mains or electrified vehicle charging stations.

One object is to provide a portable electrified vehicle backup battery that can be stowed in place of a spare tire or spare wheel on the outside of the vehicle such as to the rear, side, roof.

One object is to provide a portable electrified vehicle backup battery that can be stowed in place of a spare tire or spare wheel inside the vehicle.

One object is to provide a portable electrified vehicle backup battery which can be removably fastened to a spare wheel or spare tire mounting point.

One object is to provide a portable electrified vehicle backup battery which includes a housing for a plurality of battery modules or cells.

One object is to provide a portable electrified vehicle backup battery which can provide a method of cooling the internal electrical components.

One object is to provide a portable electrified vehicle backup battery which provides a human-machine interface for managing the charging process.

One object is to provide a portable electrified vehicle backup battery which can power other devices with alternating or direct current.

One object is to provide a portable electrified vehicle backup battery which deters from being fastened to the drive axle of the vehicle.

One object is to provide a portable electrified vehicle backup battery which provides fastening points similar to that of a spare wheel.

One object is to provide a portable electrified vehicle backup battery which can communicate to the electrified vehicle.

One object is to provide a portable electrified vehicle backup battery which can provide power to the vehicle upon which it is fastened to.

### BRIEF DESCRIPTION OF THE DRAWINGS

Example embodiments will become more fully understood from the detailed description given herein below and the accompanying drawings, wherein like elements are represented by like reference characters, which are given by way of illustration only and thus are not limitative of the example embodiments herein

FIG. 1 is a front view of the present invention. The front of the portable backup battery is seen rolling on the ground. The shape is round and similar in size to a vehicle wheel. The shape aids in the ability to be rolled on the ground when transported. It features central holes to assist in securing the battery to the vehicle. A removable charging cable is attached to the body. A user interface is located on the front to provide physical or wireless control and monitoring of the battery.

FIG. 2 is a view of the present invention secured to the rear of a vehicle. The portable backup battery is stored outside the vehicle in place of the spare tire. The cable is plugged in to charge the vehicle while still secured. The portable battery is fixed to the vehicle with fasteners normally used to retain a spare wheel.

FIG. 3 is a side view of the present invention. The portable backup battery is stored in the luggage compartment, which may either be in front or rear, of an electrified passenger vehicle. It takes the place of a spare tire inside a trunk compartment this view.

FIG. 4 is an exploded side view of the present invention. The internal view of the backup battery shows any number of battery cells or modules. Also contained are cooling mechanisms, charge controller and necessary wiring. A bidirectional inductive coil and physical connector are shown to handle charging.

FIG. 5 is a lower perspective view of the present invention. The rear of the backup battery is seen. Two deterrent mechanisms are shown to prevent fastening the device to an axle. A visual warning is displayed to the user along with an irregular surface and missing fastener holes.

### DETAILED DESCRIPTION

Vehicles typically feature a location with fastening points to retain a spare wheel and tire in the inside or on the exterior of the vehicle. Drivers of electrified vehicle may desire the ability to replenish traction battery pack charge when the vehicle is away from charging stations. In this case the portable electrified vehicle battery backup can be mounted to the vehicle in place of the spare tire for charging at any location.

Turning now descriptively to the drawings, in which similar reference characters denote similar elements throughout the several views, the figures illustrate an example embodiment. This portable backup battery can be used to charge an electrified vehicle battery. It is removably mounted to the vehicle in the place of a spare wheel or tire. When removed from the vehicle, it can be rolled on the ground to reduce transportation effort.

The silhouette of the backup battery body is round, cylindrical or other form which allows the device to be rolled on the ground. The perimeter of this shape will act as a rolling edge. The shape assists the operator to move the backup battery without lifting and carrying the device. The body contains all electronics, wiring and batteries required for the charging process. The perimeter may feature a groove or grooves to function as a cable wrap.

The center surface of the backup battery will feature fasteners or holes which allow it to be fastened to a receiving structure. Typically this would be a spare tire well in the trunk of a vehicle or the spare tire carrier on the rear of the vehicle. Captive fasteners or fasteners passing through the holes prevent relative movement of the backup battery to the vehicle. These holes or fasteners are placed along the same radius. Multiple radii and sets of holes or fasteners may exist. The center surface can also include a deterrent which prevents the backup battery from being fastened to a driven axle of the vehicle. In one instance, it could be a missing hole in the typical bolt pattern for the vehicle which could prevent all studs on an axle from engaging. In another instance, an irregular surface prevents the backup battery from mounting flush to the axle mating surface. It can also be a textual or color warning to the operator. A combination of the aforementioned features or methods not described herein which provide a sufficient deterrent to the user can be used.

The inside of the device contains componentry which can recharge an electrified vehicle via charging cable or inductive connection. This componentry includes one or more battery modules or cells. It also includes a controller module which handles charging of the internal battery. A bidirectional connector is connected to the battery modules and charge controller. The device can electrically couple through this bidirectional connector to charging stations, electrical mains, or electrified vehicles to output or accept power. The charge controller monitors and controls the charge or discharge process. The device can also support charge and discharge in the same manner through inductive means without a physical connection. One or more cooling methods allow for temperature control of batteries and electronics by allowing fluids such as liquids or gases to enter and exit the device or convect heat. The controller module may interact with a human-machine interface to display charging status. Auxiliary power can be supplied using the internal battery as a source of power for other electronics.

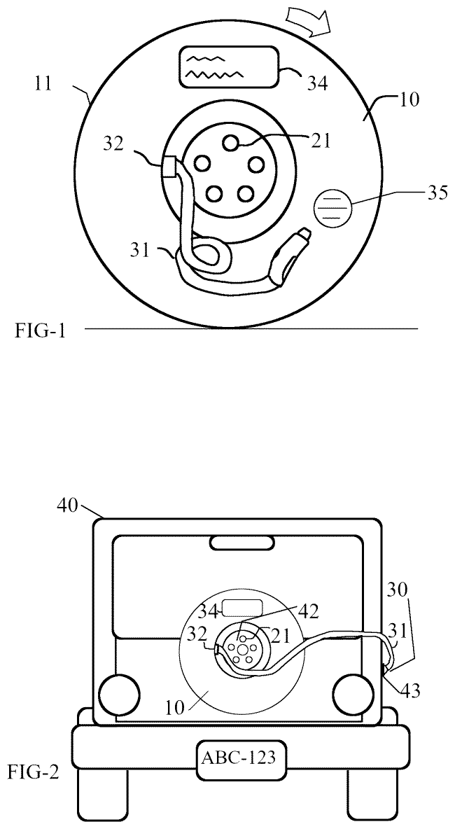

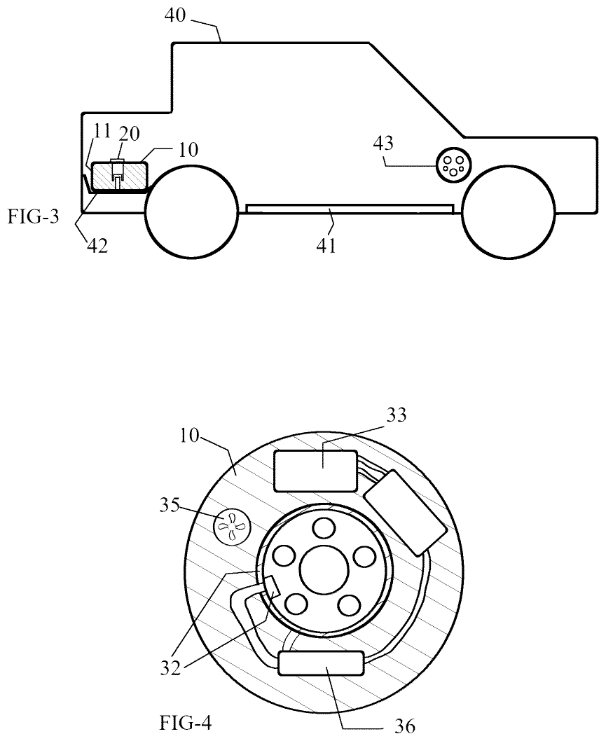

Regarding FIGS. 2-3, an example of an electrified vehicle is shown. Most electrified vehicles typically feature a traction battery pack which powers a propulsive device and a charging port to recharge the battery pack. External charging of the electrified vehicle is typically performed at a charging station. Electrified vehicles are not necessarily solely propelled by electrical means and may feature internal combustion engines in some configurations. Charging of an electrified vehicle may be desired to be performed away from a charging station.

In the same aforementioned figures, the electrified vehicle 40 features a traction battery 41, and a charging port 43 to recharge the traction battery 41. The electrified vehicle 40 also features a spare tire location 42, normally used to carry a spare tire, spare wheel or reduced size tire or wheel for emergency situations. For situations where the driver prefers a backup method of charging the traction battery 41, the portable electrified vehicle backup battery may be carried on the vehicle in the spare tire location 42, seen in FIGS. 2-3.

The body 10 forms the structure which contains all necessary parts to recharge an electrified vehicle 40 and is seen in FIGS. 1-5. The body 10 has a silhouette which enables the body 10 to be rolled on the ground while also allowing for fitment at the spare tire location 42. The outer perimeter which is rolled along the ground is the rolling edge 11. The rolling edge 11 allows the body 10 to continuously rotate on the ground without a force normal to the ground being applied to the body 10.

About the center of the body 10 are central fastening points 20 which are used to affix the portable backup battery to an electrified vehicle 40. The points are spaced in a form called the bolt pattern 21 which is typically used to define the fastener diameter, quantity, spacing and hub size of a vehicle wheel. In some applications, the portable electrified vehicle backup battery features a bolt pattern 21 which is similar to that of the electrified vehicle 40 upon which it is mounted such that the device is interchangeable with the spare wheel and tire.

The primary function of the backup battery is to provide a portable solution for electrified vehicle recharging 30 and therefore recharging the traction battery pack 41 on an electrified vehicle 40. The body 10 features an electrical bidirectional connector 32 which can send power to the charging port 43 on the electrified vehicle 40. It can also accept incoming power to charge the internal battery 33 which is managed by the charging controller 36. The charging controller 36 also energizes the bidirectional connector 32 when charging on the electrified vehicle 40 commences.

A cordset 31 is utilized to transfer power from the internal battery 33 to the charging port 43. It makes a connection to the bidirectional connector 32 at one end and the charging port 43 on the electrified vehicle 40 at the opposite end.

Once a connection from the bidirectional connector 32 to the charging port 43 is established, the charging controller 36 will power the bidirectional connector 32 using the battery 33 to charge the traction battery 41. Heat generated during a charge or discharge process is rejected from the body 10 through a cooler 35. The cooler 35 can be any method which reduces operating temperature of the device. The charge controller 36 can monitor temperature for circuit and battery protection and break current to the bidirectional connector 32 if required.

The charge controller 36 can also provide data regarding the charging process to the user interface 32. The user interface 32 is a display or data stream which can be used to provide the user with data regarding state of charge, battery health, charge status and other relevant data points the charge controller 36 can gather. In an example embodiment of portable backup battery, the user can interact with the user interface 32 to command the backup battery to end a charge early or read the energy usage. In other embodiments the user interface 32 can take the place of an application on a smartphone to provide identical function away from the backup battery body 10.

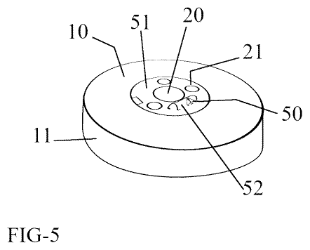

Since the bolt pattern of the portable electrified vehicle backup battery may match the bolt pattern of driven wheels on the electrified vehicle 40, a method of deterrent 50 is used. For electrified vehicles 40 that utilize studs on the axle for fastening wheel, the body central fastening 20 bolt pattern 21 may use an irregular bolt pattern 51. In this embodiment, shown in FIG. 5, it may take form as an omission of one hole to prevent all studs from passing through the backup battery body 10. In applications where the electrified vehicle 40 uses bolts for wheel fastening, an irregular surface 52 may be present on the central fastening 20 face to prevent the body 10 from sitting flush to the axle mounting face. Deterrents 50 may be a combination of both features. Other deterrents 50 may be a textual or symbolic warning to the user.

In FIG. 2, a method of charging an offroad electrified vehicle 40 traction battery 41 is shown. The electrified vehicle 40 is parked. Electrified vehicle recharging 30 occurs when the cordset 31 forms a connection between the charging port 43 and the bidirectional connector 32. The battery body 10 remains fixed to the electrified vehicle 40 on the spare tire carrier 42 via multiple fasteners fed through the bolt pattern 21. FIG. 3 shows the same backup battery stowed in the trunk of a passenger electrified vehicle 40. The battery body 10 lies flat in the spare tire well 42. In this embodiment, the body 10 is fastened to the chassis using a singular nut through the hub bore to act as the central fastening 20.

Another charging situation can occur where the backup battery may be moved closer to an electrified vehicle 40. In this situation all fasteners are removed from the central fastening 20 location on the body 10. The backup battery removed from the spare tire location 42 and is placed on the ground on the rolling edge 11, as in FIG. 1. The body 10 is rotated while the rolling edge 11 maintains contact with the ground so that lifting the body 10 is not necessary for transport.

FIG. 4 shows an internal view of the portable electrified vehicle backup battery body 10. There exists a connection between the battery 33 and the charge controller 36. The charge controller controls power flow from the battery 33 to the bidirectional connector 32. The embodiment shown in FIG. 4 utilizes a fan for a cooling method 35.

One embodiment of the bidirectional connector 32 takes form as a coil. Bidirectional power transfer takes place inductively. Charging the internal battery 33 or the traction battery 41 can occur without the body 10 and the electrified vehicle 40 being connected by a cordset 31.

The present disclosure may be embodied in other specific forms. The art is intended to be illustrative and not limiting. Various embodiments and forms may present themselves to those skilled in the art.

1. A system to provide portable electrified vehicle recharging, the system comprising of an electrified vehicle traction battery pack and a portable backup battery capable of recharging the traction battery pack, wherein the portable backup battery is removably fastened to a vehicle.

2. A system of claim 1, in which a cordset can electrically couple the backup battery and electric vehicle charging port such that the portable backup battery can charge the traction battery pack.

3. A system of claim 1, in which an inductive loop can electrically couple the backup battery and electric vehicle charging port such that the portable backup battery can charge the traction battery pack.

4. A system of claim 2, in which the cordset is not a feature belonging to the electrified vehicle.

5. A system of claim 1, in which the backup battery is capable of recharging an electrified vehicle traction battery without connections to other power sources.

6. A system of claim 1, which comprises of a housing which contains a battery assembly consisting of a plurality of battery cells or modules.

7. A system of claim 6, which contains electronics necessary to charge and discharge an internal battery and charging a traction battery.

8. A system of claim 6, which is capable of temperature regulation through a cooling method.

9. A system of claim 7, which can be removably mounted to a vehicle at spare tire stowage locations.

10. A system of claim 9, which is capable of being continuously rolled on the ground for transportation.

11. A system of claim 7, which is capable of communication with an electrified vehicle.

12. A system of claim 1, which embodies a shape which fits inside the silhouette formed by a spare wheel and tire.

13. A portable electrified vehicle backup battery charging method where an electrified vehicle is charged while the backup battery is removably mounted to a vehicle spare wheel stowage location.

14. A method of claim 13, which deters a user from fastening the backup battery to an axle.

15. A method of claim 13, which can communicate with an electrified vehicle during a recharge.

16. A method of claim 13, which is electrically coupled to the electrified vehicle using a physical or inductive connection.

17. A method of storage of a portable electrified vehicle backup battery where a spare wheel is removed from a vehicle and the backup battery is stowed directly in its place, being secured by one or more fasteners about the center.
